(19) United States
(12) Patent Application Publication
(10) Pub. No.: US 2008/0095040 A1
(43) Pub. Date: Apr. 24, 2008

(54) METHOD AND APPARATUS FOR TRANSMITTING AND RECEIVING ACK/NACK SIGNAL TO SUPPORT HYBRID AUTOMATIC REPEAT REQUEST FOR MULTI-LAYER TRANSMISSION

(75) Inventors: Hwan-Joon Kwon, Suwon-si (KR); Dong-Hee Kim, Yongin-si (KR); Jae-Chon Yu, Suwon-si (KR); Jio-Kyu Han, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/923,379

(22) Filed: Oct. 24, 2007

(30) Foreign Application Priority Data
Oct. 24, 2006 (KR) 103723/2006

(51) Int. Cl. H04J 11/00

(52) U.S. Cl. 370/210

(57) ABSTRACT

A method and apparatus for transmitting an Acknowledge (ACK)/Non-Acknowledge (NACK) signal to support Hybrid Automatic Repeat reQuest (H-ARQ) in an Orthogonal Frequency Division Multiplexing (OFDM) system are provided. A controller selects one of a plurality of Discrete Fourier Transform (DFT) input positions mapped to data channels over which a received data stream is transmitted in a group corresponding to a layer over which the received data stream is transmitted. The plurality of input positions is grouped into N groups for N layers for transmitting different data streams, and the input positions in each group are mapped to different data channels. A transmission module transmits an ACK/NACK signal for the received data stream over the DFT input position selected by the controller.

### PRIORITY

This application claims priority under 35 U.S.C. §119(a) to a Korean Patent Application filed in the Korean Intellectual Property Office on Oct. 24, 2006 and assigned Serial No. 2006-103723, the disclosure of which is incorporated herein by reference.

### BACKGROUND OF THE INVENTION

1. Field of the Invention

The present invention relates generally to an apparatus and method for transmitting a reverse response signal in a mobile communication system, and more particularly, to a method and apparatus for transmitting and receiving an Acknowledge (ACK) signal and a Non-Acknowledge (NACK) signal to support Hybrid Automatic Repeat reQuest (H-ARQ) for the data transmitted by a base station over multiple layers in a mobile packet data communication system based on Orthogonal Frequency Division Multiple Access (OFDM).

2. Description of the Related Art

H-ARQ is an important technology used to increase the reliability and throughput of data transmission in the packet-based mobile communication system. ‘H-ARQ technology’, as used herein, refers to a merger of Automatic Repeat reQuest (ARQ) technology and Forward Error Correction (FEC) technology. In ARQ technology, popularly used in the wire/wireless data communication system, a transmitter assigns sequence numbers to transmission data packets according to a predefined scheme before transmission, and a data receiver sends the transmitter a retransmission request for the data packet with a missing number among the numbers of the received data packets, thereby achieving the reliable data transmission. In FEC technology, a transmitter adds predetermined redundant bits to transmission data using a coding technology such as convolutional coding or turbo coding before transmission, thereby coping with the noises generated in the data transmission/reception process and the error occurring in, for example, the fading environment. In this manner, FEC technology demodulates the originally transmitted data.

In a system employing H-ARQ, or the combination of ARQ and FEC technologies, a data receiver determines presence/absence of error by performing Cyclic Redundancy Check (CRC) on the data decoded through an inverse FEC process of the FEC process performed on the received data by a data transmitter. In the absence of error, the data receiver feeds back an ACK message to the data transmitter so that the data transmitter may transmit the next data packet. However, in the presence of error in the received data, the data receiver feeds back a NACK message to the data transmitter so that the data transmitter may retransmit the previously transmitted packet. The data receiver combines the retransmitted packet with the previously received packet to obtain energy gain. As a result, H-ARQ can obtain the improved performance compared to the conventional ARQ that does not support the combining process.

FIG. 1 is a diagram illustrating the concept of general H-ARQ.

Referring to FIG. 1, the horizontal axis indicates the time axis, and 101 indicates initial transmission. In FIG. 1, the ‘data channel’ indicates the channel over which data is actually transmitted. Upon receiving data at 101, a receiver attempts demodulation for the data channel. In this process, if it is determined that the data transmission has failed in the demodulation as a result of CRC check on the data channel, the receiver feeds back a NACK message to a data transmitter at 102. Upon receiving the NACK message at 102, the data transmitter performs, at 103, first retransmission on the data transmitted at the initial transmission 101.

Therefore, note that the data channel at the initial transmission 101 and the data channel at the first retransmission 103 transmit the same information. It should be noted herein that the data channels, although they transmit the same information, could be different redundancies. The data transmissions for transmitting the same information, i.e. the transmissions for transmitting the same information, indicated by 101, 103, 105, and so on, each will be referred to as a subpacket. Upon receiving the data transmitted at the first retransmission time 103, the data receiver combines the data received at the first retransmission time 103 with the initial transmission data received at 101 according to a predetermined rule, and attempts demodulation of the data channels depending on the combining result.

If it is determined that the transmitted data has failed in the demodulation as a result of CRC check on the data channels, the data receiver feed backs a NACK message to the data transmitter as shown by 104. Upon receiving the NACK message 104, the data transmitter performs second retransmission at 105, which falls a predetermined interval behind the first retransmission time 103. Therefore, all data channels for the initial transmission 101, the first retransmission 103, and the second retransmission 105 transmit the same information.

Upon receiving the second retransmission data at 105, the data receiver combines all of the initial transmission 101, the first retransmission 103 and the second retransmission 105 according to a predetermined rule, and performs demodulation of the data channels using the combining results. It is assumed that the transmission data has been successfully demodulated as a result of the CRC check on the data channels.

In this case, the data receiver feeds back an ACK message 106 to the data transmitter. Upon receiving the ACK message 106, the data transmitter transmits an initial transmission subpacket for the next data information as shown by 107. Here, the initial transmission 107 can be immediately performed at the time where the data transmitter has received the ACK message at 106, or can be performed after a lapse of a predetermined time: this is determined depending on the scheduling result.

To support H-ARQ as described above, the data receiver should feed back an ACK/NACK message to the data transmitter, and the channel for transmitting the ACK/NACK message is called an ACK channel (ACKCH).

A multi-antenna technology for increasing the data rate or the system throughput includes Spatial Multiplexing (SM) and/or Spatial Domain Multiple Access (SDMA). SM refers to the technology in which a data transmitter transmits multiple data streams to one data receiver over several antennas, while SDMA refers to the technology in which a data transmitter transmits multiple data streams to multiple data receivers over several antennas. The SM and SDMA technologies will be referred to herein as a multi-layer transmission technology.

That is, the ‘multi-layer transmission technology’ as used herein refers to the technology in which a base station simultaneously transmits multi-packet data for several users over the same time/frequency resources using several transmit antennas, or transmits the multi-packet data to one user.

When the data transmissions for multiple layers are performed and different data streams are transmitted through the multiple layers as described above, i.e. when the multiple packets are transmitted, an effective ACKCH should be designed to support H-ARQ for each of the layers. A description will now be made of the conventional ACKCH transmission method for the case where it supports H-ARQ in transmitting data streams through the multiple layers.

A description will first be made of a resource allocation method and its transmission method for an ACKCH for one layer in the conventional OFDMA system.

In the common OFDMA system, one forward data resource channel is defined by multiple adjacent OFDMA symbols in the time domain and multiple subcarriers in the frequency domain. It is assumed that 8 OFDMA symbols and 16 subcarriers are bound to form one forward data resource channel. For example, in a certain system, if the total number of subcarriers available in the frequency domain is 480 and one forward data resource channel includes 16 subcarriers, the system has 30 (= 480/16) forward data resource channels. In this case, the maximum number of ACK/NACK bits transmitted over the reverse link is 30, because 1-bit reverse ACK/NACK feedback can be transmitted for each of forward data resource channels. Therefore, resources should be secured such that transmission of reverse ACK/NACK responses, the number of which is equal to the number of forward data resource channels, is possible. Under the above assumption, a description will now be made regarding resource allocation for the reverse ACK/NACK transmission and how the ACK/NACK transmission is performed in detail.

FIG. 2 is a diagram illustrating a transmitter structure of a mobile station for transmitting an ACK/NACK response over a reverse link (RL) to respond to the data received over a forward link (FL) in the general communication system.

Referring to FIG. 2, 201 indicates an ACK/NACK bit the mobile station transmits over the reverse link. Its value is determined depending on whether a mobile station has succeeded in demodulation of its received forward data, or has failed in the demodulation and thus issued a retransmission request. The ACK/NACK 201 is input to a 16-point Discrete Fourier Transformer (DFT) 203. Of the input positions of the DFT 203, only the positions corresponding to the forward resource channel over which the mobile station receives data in the forward link are used, and ‘0’s are input to the remaining inputs in a zero inserter 202.

For example, in the case where there are 30 forward data resource channels #0 to #29 and the data is transmitted to the mobile station over the forward data resource channel #0, as the forward data resource channel #0 is previously mapped to an input position #0 of the 16-point DFT 203, the mobile station transmits an ACK/NACK bit for the data received over the forward data resource channel #0 using only the DFT 203 input position #0 (input position #0 of the DFT 203), and fills, with ‘0’s, the values being input to the remaining input positions of the 16-point DFT 203. This process is controlled by a controller 210. Outputs of the DFT 203 undergo a subcarrier mapping process in a subcarrier mapper 204, and through this process, the outputs of the DFT 203 are mapped to the positions of predetermined subcarriers among the 480 subcarriers.

When the OFDM system is assumed to employ a 512-size Fast Fourier Transformer (FFT), the subcarrier positions corresponding to the remaining values except for the output values of the subcarrier mapper 204 are filled with ‘0’s in a zero inserter 205. If the positions of the subcarriers corresponding to the remaining values except for the outputs of the subcarrier mapper 204 are filled with ‘0’s by the zero inserter 205, the resulting signal is transmitted through the general OFDM symbol generation procedure by means of an Inverse Fast Fourier Transformer (IFFT) 206, a Parallel-to-Serial (P/S) converter 207, and a Cyclic Prefix (CP) adder 208.

FIG. 3 illustrates a subcarrier mapping process performed in the subcarrier mapper 204 of FIG. 2, and a detailed mapping relationship for transmission of the general forward resource channels and reverse ACK/NACK bits. FIG. 4 illustrates an ACK/NACK bit allocation method for DFT input positions in the general communication system.

In FIG. 2, the 16-point DFT 203 has 16 output values, and the 16 values are mapped to the part indicated by 300 in FIG. 3.

In FIG. 3, the horizontal axis of 310 indicates the time axis, and one lattice in the time axis indicates one-OFDM symbol interval. The vertical axis indicates the frequency axis, and one lattice in the frequency axis indicates one subcarrier. In FIG. 3, 310 is also called a tile in the general OFDM system, and this is a basic resource allocation unit for reverse transmission. In FIGS. 3, 300, 302, 304 and 306 each consist of 16 lattices. That is, 8 consecutive subcarriers are disposed over two OFDM symbols.

Therefore, the tile has a structure with which the outputs of the 16-point DFT 203 can be transmitted. It was mentioned in the prior art that there is a one-to-one mapping relationship between the forward data resource channels and the input positions of the DFT 203. That is, ACK/NACK bits for the forward data resource channels #0 to #7 are mapped to the DFT 203 input positions #0 to #7 (400), and ACK/NACK bits corresponding to the forward data resource channels #0 to #7 are carried on 300 over the reverse link. In the same manner, ACK/NACK bits for the forward data resource channels #8 to #15 are mapped to the DFT 203 input positions #0 to #7 (400), and ACK/NACK bits corresponding to the forward data resource channels #8 to #15 are carried on 302 over the reverse link. ACK/NACK bits for the forward data resource channels #16 to #23 are mapped to the DFT 203 input positions #0 to #7 (400), and ACK/NACK bits corresponding to the forward data resource channels #16 to #23 are carried on 304. ACK/NACK bits for the forward data resource channels #24 to #29 are mapped to the DFT 203 input positions #0 to #6, and ACK/NACK bits corresponding to the forward data resource channels #24 to #29 are carried on 306. In this way, the parts 300 to 306 corresponding to the half of one tile shown in FIG. 3 are used for reverse ACK/NACK bit transmission, and 300, 302, 304 and 306 each are commonly called a subtile.

Therefore, because ACK/NACK bits corresponding to 8 forward data resource channels can be transmitted over one subtile, the mobile station can transmit ACK/NACK bits corresponding to 32 forward data resource channels over 4 subtiles as shown in FIG. 3.

For repetitive transmission, 3 tiles having the same structure as that of FIG. 3 are additionally used, so a total of 4 tiles having the same structure as that of FIG. 3 are used for reverse ACK/NACK transmission. The 4 tiles have a structure in which they are simply repeated. The 4 tiles are separated from each other in the frequency axis without being adjacent to each other, to increase the reception reliability for the ACK/NACK transmission using the frequency diversity effect.

In summary, for reverse ACK/NACK bit transmission, a total of 16 subtiles (‘4 subtiles’×‘total of 4 tiles’) are used. Because the total number of subcarriers available in the frequency domain is 480 as stated above, the 16 subtiles are equivalently equal to the resources corresponding to 2 reverse tiles among a total of 30 available reverse tiles, so 2 reverse tiles are equivalently used for the reverse ACK/NACK bit transmission. Here, the reason why the DFT 203 input positions #8 to #15 (402) are unused for all subtiles is to use the positions #8 to #15 among the DFT 203 input positions for a purpose of measuring an interference (i.e. amount of interference) for each subtile at a receiver of a base station. One ACK/NACK bit is repeatedly transmitted over 4 subtiles as described above, and the 4 subtiles 300 to 306 undergo different interferences. Upon receiving the ACK/NACK bit, the base station receiver measures an interference for each individual subtile in a process of demodulating one ACK/NACK bit which is repeatedly transmitted 4 times over the 4 subtiles 300 to 306 for diversity gain, and differentiates a weight in a process of combining the 4-times repeated ACK/NACK bits using the measured interference, thereby improving the reception performance. The foregoing ACK/NACK allocation method for the DFT 203 input positions is shown in FIG. 4.

When the system supporting data stream transmission over multiple layers in the forward link extends the method used for ACK/NACK bit transmission for the data streams received over one layer described in FIGS. 2 and 3, simply according to the number of layers, in a resource allocation and its transmission method for the reverse ACK/NACK bit transmission, the resources needed for ACK/NACK bit transmission in the reverse link becomes a tile corresponding to 2×‘number of layers’. For example, when 2 layers are used for data streams in the forward link, 4 tiles are needed for ACK/NACK bit transmission in the reverse link, and when 4 layers are used for transmitting data streams in the forward link, a total of 8 tiles are needed for ACK/NACK bit transmission in the reverse link. This means that 13.3% and 26.7% of reverse tiles are used only for ACK/NACK bit transmission for the two cases, respectively, causing excessive resource use for the ACK/NACK bit transmission.

To address the above problems, when transmission of multiple data streams is achieved through multiple layers in the forward link, the conventional communication system uses a method of increasing the resource allocation unit for transmission of the data streams. For example, when there are 30 forward data resource channels as stated above, the method of transmitting a data stream over one layer can allocate each forward data resource channel to each mobile station. However, when transmitting two data streams over two layers in the forward link, the system binds resource channels on a two-by-two basis for resource allocation. In the same manner, when 4 data streams are transmitted over 4 layers in the forward link, the system binds resource channels on a four-by-four basis for resource allocation.

FIG. 5 illustrates a method for inputting to a DFT a reverse ACK/NACK bit for the data streams that a base station has received for each individual layer when data streams are transmitted over two layers in the forward link in the general OFDMA system.

Referring to FIG. 5, for example, when two layers are used in the forward link (FL), data is transmitted to a mobile station A and a mobile station B over two layers using a forward data resource channel #0, and data is transmitted to a mobile station C and a mobile station D over two layers using a forward data resource channel #1. In this case, the reverse link, compared to the forward link, needs the doubled ACK/NACK resources. To avoid this, the resource channels are bound on a two-by-two basis for the forward resource allocation unit.

That is, when two layers are used to transmit data in the forward link, data is transmitted to a mobile station A and a mobile station B over forward data resource channels #0 and #1 using two layers, and 2-layer transmission is performed to a mobile station C and a mobile station D over forward data resource channels #2 and #3. When data transmission is performed to the mobile station A and the mobile station B over two layers using the forward data resource channel #0 and the forward data resource channel #1 as stated above, the reverse ACK/NACK bit transmission method allows the mobile station A receiving a first layer as shown by reference numeral 500 to use the DFT 203 input position for transmitting an ACK/NACK bit for the data received over the forward data resource channel #0, and allows the mobile station B receiving a second layer as shown by reference numeral 502 to use the DFT 203 input position for transmitting an ACK/NACK bit for the data received over the forward data resource channel #1, thereby supporting H-ARQ for the forward multi-layer transmission without increasing the reverse ACK/NACK resources.

That is, in FIG. 5, the mobile station A uses the DFT input position #0 as a DFT 203 input where it will transmit an ACK/NACK bit for the data received over the forward data resource channel #0, and the mobile station B uses the DFT input position #1 as a DFT 203 input where it will transmit an ACK/NACK bit for the data received over the forward data resource channel #1.

The above method is extended to a similar method when data streams are transmitted over more layers in the forward link.

For example, when data streams are transmitted over four layers in the forward link, resource channels are bound on a four-by-four basis for the resource allocation unit. In this case, the mapping relationship between the DFT input positions and the forward channels corresponding to the ACK/NACK bits will be described with reference to FIG. 6.

FIG. 6 illustrates a mapping method between ACK/NACK bits and DFT input positions for reverse ACK/NACK bit transmission that a mobile station will perform for data streams transmitted separately for each individual layer when four data streams are independently transmitted over four layers in the forward link in the general OFDMA system.

That is, when four layers are used for data transmission in the forward link, a base station performs, over four layers, forward data transmission to a mobile station A, a mobile station B, a mobile station C, and a mobile station D, to which it has allocated resource channels #0, #1, #2 and #3 as shown in FIG. 6. In this case, the reverse ACK/NACK bit transmission method is defined as follows.

The mobile station A receiving a data stream over a first layer uses an input position #0 among the DFT 203 input positions corresponding to the forward data resource channels #0, #1, #2 and #3 as shown by reference numeral 600. The mobile station B receiving a data stream over a second layer uses an input position #1 among the DFT 203 input positions corresponding to the forward data resource channels #0, #1, #2 and #3 as shown by reference numeral 602. The mobile station C receiving a data stream over a third layer uses an input position #2 among the DFT 203 input positions corresponding to the forward data resource channels #0, #1, #2 and #3 as shown by reference numeral 604. The mobile station D receiving a data stream over a fourth layer uses an input position #3 among the DFT 203 input positions corresponding to the forward data resource channels #0, #1, #2 and #3 as shown by reference numeral 606. In this manner, the reverse ACK/NACK bit transmission method supports H-ARQ for forward four-layer transmission without increasing the resources for reverse ACK/NACK bit transmission.

In the foregoing, the DFT input position using method for reverse ACK/NACK bit transmission over two layers in the forward link and the DFT input position using method for reverse ACK/NACK bit transmission over four layers in the forward link are shown in FIGS. 5 and 6, respectively.

The foregoing method is disadvantageous in that it reduces flexibility of the forward resource allocation to save resources necessary for reverse ACK/NACK transmission in supporting H-ARQ for multiple forward data transmissions.

### SUMMARY OF THE INVENTION

The present invention has been made to address at least the above problems and/or disadvantages and to provide at least the advantages described below. Accordingly, an aspect of the present invention provides a method and apparatus for transmitting and receiving reverse ACK/NACK bits for data streams in a reception apparatus upon receiving the data streams over multiple layers in a mobile communication system that transmits data streams over multiple layers.

Another aspect of the present invention provides a reverse ACK/NACK transmission/reception method and apparatus for minimizing resources necessary for transmission of reverse ACK/NACK bits in a mobile communication system supporting H-ARQ for multiple forward data transmissions.

An additional aspect of the present invention provides a reverse ACK/NACK bit transmission/reception method and apparatus for maximally guaranteeing flexibility of forward resource allocation in a mobile communication system supporting H-ARQ for multiple forward data transmissions.

According to one aspect of the present invention, a method for transmitting an Acknowledge (ACK)/Non-Acknowledge (NACK) signal to support Hybrid Automatic Repeat reQuest (H-ARQ) in an Orthogonal Frequency Division Multiplexing (OFDM) system is provided. One of a plurality of Discrete Fourier Transformer (DFT) input positions mapped to data channels over which a received data stream is transmitted in a group corresponding to a layer over which the received data stream is transmitted is selected. The plurality of input positions is grouped into N groups separately for N layers for transmitting different data streams, and the input positions in each group are mapped to different data channels. An ACK/NACK signal for the received data stream is transmitted over the selected DFT input position.

According to another aspect of the present invention, a method for receiving an Acknowledge (ACK)/Non-Acknowledge (NACK) signal to support Hybrid Automatic Repeat reQuest (H-ARQ) in an Orthogonal Frequency Division Multiplexing (OFDM) system is provided. One of a plurality of Discrete Fourier Transformer (DFT) input positions mapped to data channels over which a data stream is transmitted in a group corresponding to a layer over which the data stream is transmitted is selected. The plurality of input positions is grouped into N groups for N layers for transmitting different data streams, and the input positions in each group are mapped to different data channels. An ACK/NACK signal for the transmitted data stream is received over the selected DFT input position.

According to a further aspect of the present invention, an apparatus for transmitting an Acknowledge (ACK)/Non-Acknowledge (NACK) signal to support Hybrid Automatic Repeat reQuest (H-ARQ) in an Orthogonal Frequency Division Multiplexing (OFDM) system is provided. The transmission apparatus includes a controller for selecting one of a plurality of Discrete Fourier Transformer (DFT) input positions mapped to data channels over which a received data stream is transmitted in a group corresponding to a layer over which the received data stream is transmitted. The plurality of input positions is grouped into N groups for N layers for transmitting different data streams, and the input positions in each group are mapped to different data channels. The transmission apparatus also includes a transmission module for transmitting an ACK/NACK signal for the received data stream over the DFT input position selected by the controller.

According to yet another aspect of the present invention, an apparatus for receiving an Acknowledge (ACK)/Non-Acknowledge (NACK) signal to support Hybrid Automatic Repeat reQuest (H-ARQ) in an Orthogonal Frequency Division Multiplexing (OFDM) system is provided. The reception apparatus includes a controller for selecting one of a plurality of Discrete Fourier Transformer (DFT) input positions mapped to data channels over which a data stream is transmitted in a group corresponding to a layer over which a data stream is transmitted. The plurality of input positions is grouped into N groups separately for N layers for transmitting different data streams, and the input positions in each group are mapped to different data channels. The reception apparatus also includes a reception module for receiving an ACK/NACK signal for the transmitted data stream over the DFT input position selected by the controller.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating the concept of general H-ARQ;

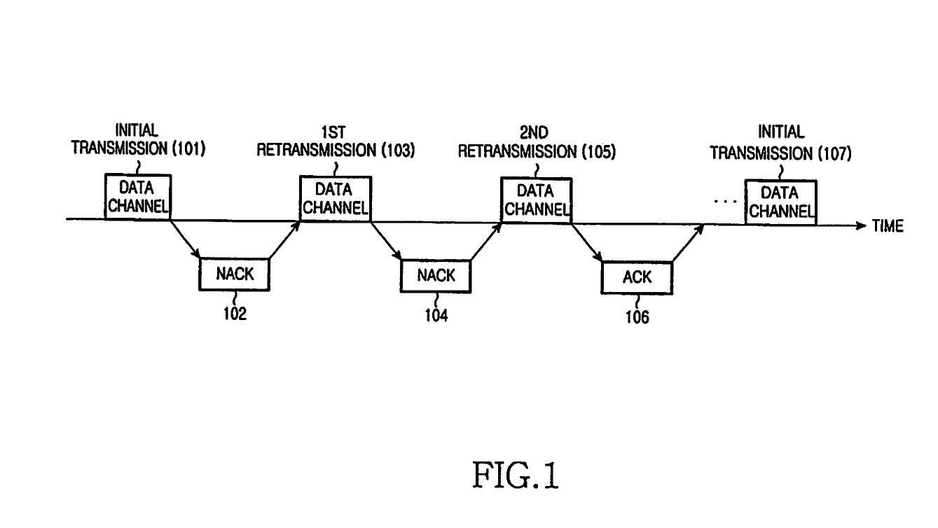

FIG. 2 is a diagram illustrating a transmitter structure of a mobile station for transmitting an ACK/NACK response over a reverse link (RL) in the general communication system;

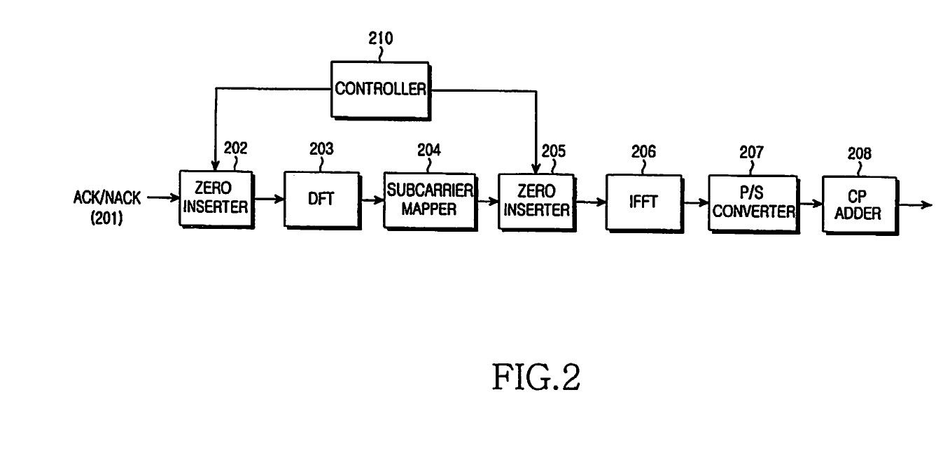

FIG. 3 is a diagram illustrating a subcarrier mapping process performed in the subcarrier mapper of FIG. 2 and a detailed mapping relationship for transmission of the general forward resource channels and reverse ACK/NACK bits;

FIG. 4 is a diagram illustrating an ACK/NACK bit allocation method for DFT input positions in the general communication system;

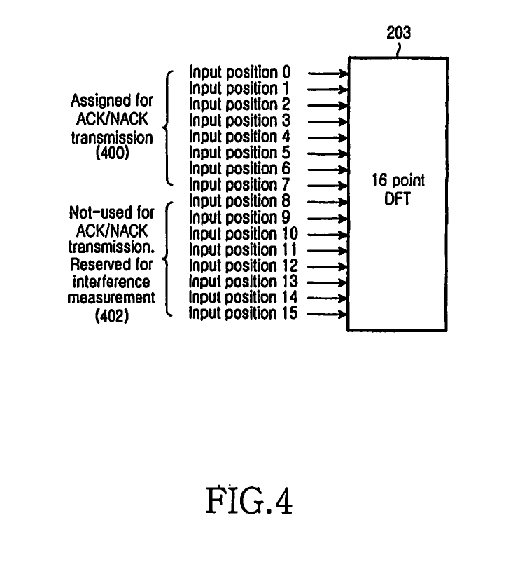

FIG. 5 is a diagram illustrating a DFT input method for reverse ACK/NACK transmission by a mobile station when two layers are transmitted in a forward link in the general OFDMA system;

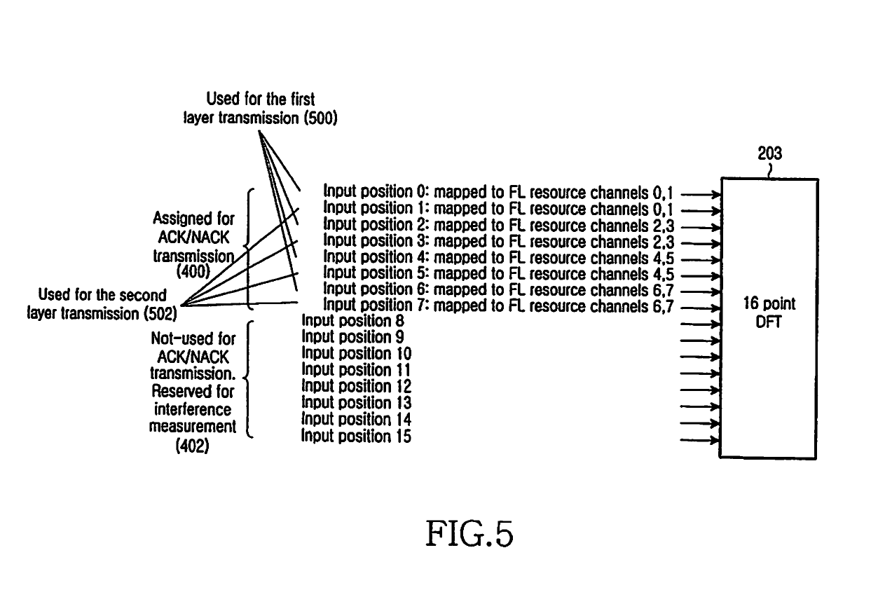

FIG. 6 is a diagram illustrating a DFT input method for reverse ACK/NACK transmission by a mobile station when four layers are transmitted in a forward link in the general OFDMA system;

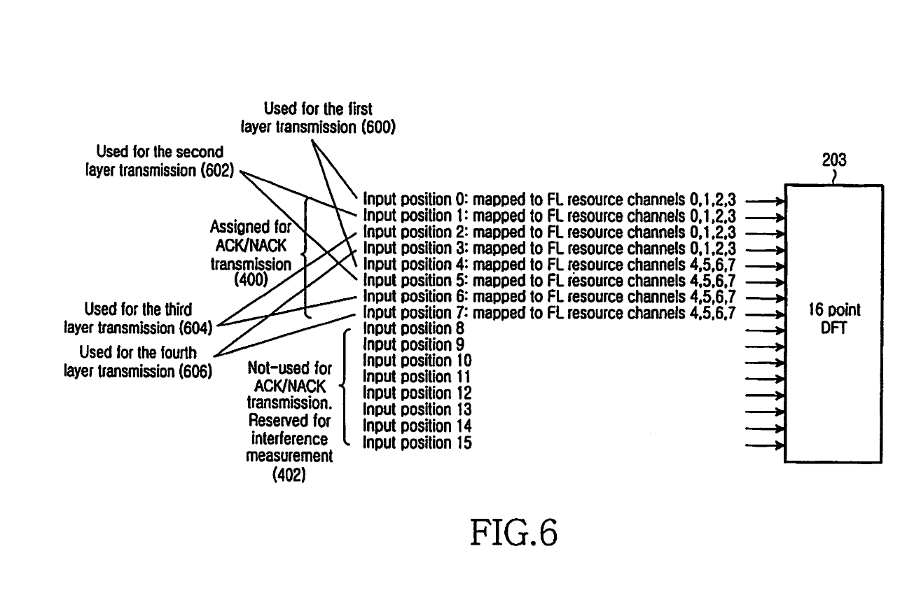

FIG. 7 is a diagram illustrating a relationship between forward data resource channels for two layers and resources mapped to DFT input positions for reverse ACK/NACK bit transmission when forward data transmission is performed over two layers according to an embodiment of the present invention;

FIG. 8 is a diagram illustrating a mapping relationship between forward data resource channels for four layers and DFT input positions for reverse ACK/NACK bit transmission when forward data transmission is performed over four layers according to an embodiment of the present invention;

FIG. 9 is a diagram illustrating a structure of an ACK/NACK transmitter according to an embodiment of the present invention; and

FIG. 10 is a diagram illustrating a structure of an ACK/NACK receiver according to an embodiment of the present invention.

### DETAILED DESCRIPTION OF THE PREFERRED EMBODIMENTS

Preferred embodiments of the present invention are described in detail with reference to the accompanying drawings. It should be noted that similar components are designated by similar reference numerals although they are illustrated in different drawings. Detailed descriptions of constructions or processes known in the art may be omitted to avoid obscuring the subject matter of the present invention.

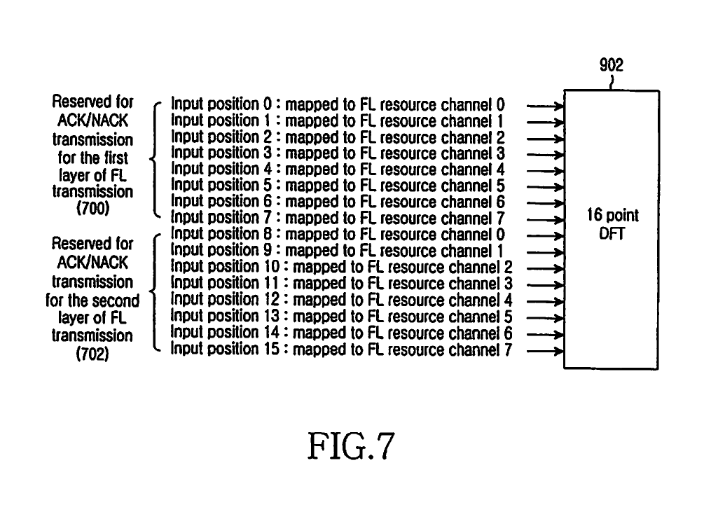

FIG. 7 is a diagram illustrating a relationship between forward data resource channels for two layers and resources mapped to DFT input positions for reverse ACK/NACK bit transmission when forward data transmission is performed over two layers according to an embodiment of the present invention.

As illustrated in FIG. 7, when data is transmitted over two layers in the forward link, the mapping relationship between forward data resource channels and DFT 902 input positions for reverse ACK/NACK bit transmission, proposed by the present invention, is defined as follows.

Although the demodulation result on the data received over the forward data resource channel being input to the DFT input positions will be referred to herein as an ACK/NACK bit for convenience, an ACK/NACK message or ACK/NACK signal including the demodulation result on the received data can be input to the DFT input positions.

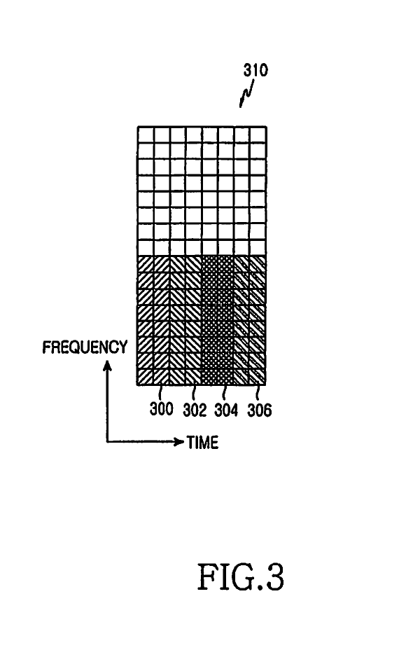

DFT 902 input positions #0 to #7 (700) to be mapped to a first subtile 300 in FIG. 3 are allocated for the forward data resource channels #0 to #7 corresponding to a first layer, and DFT 902 input positions #8 to #15 (702) to be mapped to the first subtile are allocated for the forward data resource channels #0 to #7 corresponding to a second layer. Although not shown in FIG. 7, the same method is applied to the remaining forward data resource channels.

That is, DFT input positions #0 to #7 (700) to be mapped to a second subtile (i.e. to be mapped to reference numeral 302 in FIG. 3) are allocated for the forward data resource channels #8 to #15 corresponding to the first layer, and DFT input positions #8 to #15 (702) to be mapped to the second subtile are allocated for the forward data resource channels #8 to #15 corresponding to the second layer. In the same manner, DFT input positions #0 to #7 (700) to be mapped to a third subtile (i.e. to be mapped to reference numeral 304 in FIG. 3) are allocated for the forward data resource channels #16 to #23 corresponding to the first layer, and DFT input positions #8 to #15 (702) to be mapped to the third subtile are allocated for the forward data resource channels #16 to #23 corresponding to the second layer.

In the same manner, DFT input positions #0 to #7 (700) to be mapped to a fourth subtile (i.e. to be mapped to reference numeral 306 in FIG. 3) are allocated for the forward data resource channels #24 to #31 corresponding to the first layer (under the assumption that there are 32 forward data resources and if the number of forward data resource channels is 30, the remaining forward data resource channels are unused), and DFT input positions #8 to #15 (702) to be mapped to the fourth subtile 306 are allocated for the forward data resource channels #24 to #31 corresponding to the second layer.

The present invention should also necessarily ensure that 8 of the DFT 902 input positions are unused. This is so that they may be used in measuring an interference for each subtile as described above. However, as shown in FIG. 7, it can be understood that all DFT input positions are available in the mapping relationship between the forward data resource channels corresponding to two layers used for forward data stream transmission and the DFT input positions for reverse ACK/NACK bit transmission for the data streams received over the two layers, proposed by the present invention.

Therefore, for interference measurement with the mapping relationship, it should be ensured that at least 8 of the 16 input positions are always unused, and this means that there is a need for some restriction on the forward resource allocation. A detailed description will now be made of a reverse ACK/NACK bit transmission method according to an embodiment of the present invention under the assumption that resource channels are bound on a two-by-two basis for forward resource allocation. For convenience, it is assumed that there are a total of 8 forward data resource channels.

That is, in this case, only one DFT is needed for reverse ACK/NACK bit transmission. For example, let's assume that a base station transmits data streams to mobile stations A and B over forward data resource channels #0 and #1 and their associated two layers, transmits data streams to mobile stations C and D over forward data resource channels #2 and #3 and their associated two layers, transmits data streams to mobile stations E and F over forward data resource channels #4 and #5 and their associated two layers, and transmits data streams to mobile stations G and H over forward data resource channels #6 and #7 and their associated two layers.

That is, in this case, the mobile station A receives a data stream over a first layer of the forward data resource channels #0 and #1; the mobile station B receives a data stream over a second layer of the forward data resource channels #0 and #1; the mobile station C receives a data stream over a first layer of the forward data resource channels #2 and #3; the mobile station D receives a data stream over a second layer of the forward data resource channels #2 and #3; the mobile station E receives a data stream over a first layer of the forward data resource channels #4 and #5; the mobile station F receives data stream over a second layer of the forward data resource channels #4 and #5; the mobile station G receives a data stream over a first layer of the forward data resource channels #6 and #7; and the mobile station H receives a data stream over a second layer of the forward data resource channels #6 and #7.

In this case, as to the mobile station A, because its allocated resources are the forward resource channels #0 and #1 and it receives a data stream over the first layer, DFT input positions to be used for reverse ACK/NACK bit transmission corresponding thereto, referring to FIG. 7, are DFT input positions #0 and #1 and the mobile station A transmits an ACK/NACK bit over the DFT input position #0 out of them. This is the case in which when the mobile station receives a data stream over multiple forward data resources, it uses only the DFT input position corresponding to the forward data resource channel with the lowest index among the multiple forward data resource channels. On the contrary, the mobile station can use only the DFT input position corresponding to the forward data resource channel with the highest index among the multiple forward data resource channels.

As to the mobile station B, because its allocated resources are the forward resource channels #0 and #1 and it receives a data stream over the second layer, DFT input positions for reverse ACK/NACK bit transmission corresponding to the received data stream, referring to FIG. 7, are DFT input positions #8 and #9 and the mobile station B transmits an ACK/NACK bit over the DFT input position #8 out of them.

As to the mobile station C, because its allocated resources are the forward resource channels #2 and #3 and it receives a data stream over the first layer, DFT input positions for reverse ACK/NACK bit transmission corresponding thereto, referring to FIG. 7, are DFT input positions #2 and #3 and the mobile station C performs ACK/NACK bit transmission over the DFT input position #2 out of them. As to the mobile station D, because its allocated resources are the forward resource channels #2 and #3 and it receives a data stream over the second layer, DFT input positions for reverse ACK/NACK bit transmission corresponding thereto, referring to FIG. 7, are DFT input positions #10 and #11 and the mobile station D transmits an ACK/NACK bit over the DFT input position #10 out of them. As to the mobile station E, because its allocated resources are the forward resource channels #4 and #5 and it receives a data stream over the first layer, DFT input positions for reverse ACK/NACK bit transmission corresponding thereto, referring to FIG. 7, are DFT input positions #4 and #5 and the mobile station E transmits an ACK/NACK bit over the DFT input position #4 out of them.

As to the mobile station F, because its allocated resources are the forward resource channels #4 and #5 and it receives a data stream over the second layer, DFT input positions for reverse ACK/NACK bit transmission corresponding thereto, referring to FIG. 7, are DFT input positions #12 and #13 and the mobile station F transmits an ACK/NACK bit over the DFT input position #12 out of them. As to the mobile station G, because its allocated resources are the forward resource channels #6 and #7 and it receives a data stream over the first layer, DFT input positions for reverse ACK/NACK bit transmission corresponding thereto, referring to FIG. 7, are DFT input positions #6 and #7 and the mobile station G transmits an ACK/NACK bit over the DFT input position #6 out of them. As to the mobile station H, because its allocated resources are the forward resource channels #6 and #7 and it receives a data stream over the second layer, DFT input positions for reverse ACK/NACK bit transmission corresponding thereto, referring to FIG. 7, are DFT input positions #14 and #15 and the mobile station H transmits an ACK/NACK bit over the DFT input position #14 out of them.

In summary, it can be noted that the DFT input positions used by the mobile stations are DFT input positions #0, #2, #4, #6, #8, #10, #12 and #14, and the remaining DFT input positions #1, #3, #5, #7, #9, #11, #13 and #15 are unused. The base station calculates indexes of the DFT input positions that the mobile stations will not use for ACK/NACK bit transmission according to the resource allocation result among the DFT input positions as described above, and measures an interference of the corresponding subtile through a predetermined procedure using them. As illustrated above by way of example, because 8 DFT inputs are unused, the base station can maintain the constant performance in measuring the interference of the corresponding subtile.

That is, the decrease in the number of unused DFT input positions reduces the number of samples used for measuring the interference, causing an influence on accuracy of the interference measurement. However, when resource channels are bound on a two-by-two basis for all resource channels as described above, the present invention provides the same effect and performance as those of the prior art. With frequency, however, the actual system can allocate more than three resource channels to one mobile station in transmitting data streams over multiple layers. As a matter of fact, the present invention is more advantageous for this case. A description thereof will be made by way of example.

For convenience, a description of an embodiment of the present invention will be made herein for the case where the total number of forward data resource channels is 8. For example, let's assume that the base station transmits data streams to the mobile stations A and B over forward data resource channels #0, #1, #2 and #3 and their associated two layers. That is, the mobile station A receives a data stream over a first layer of the forward data resource channels #0, #1, #2 and #3, and the mobile station B receives a data stream over a second layer of the forward data resource channels #0, #1, #2 and #3. In this case, the mobile station A transmits an ACK/NACK bit using the DFT input position #0 according to FIG. 7, and the mobile station B transmits an ACK/NACK bit using the DFT input position #8 according to FIG. 7. Further, let's assume that the base station simultaneously transmits data streams to the mobile stations C and D over forward data resource channels #4 and #5 and their associated two layers. That is, the mobile station C receives a data stream over a first layer of the forward data resource channels #4 and #5, and the mobile station D receives a data stream over a second layer of the forward data resource channels #4 and #5. In this case, the mobile station C transmits an ACK/NACK bit using the DFT input position #4 according to FIG. 7, and the mobile station D transmits an ACK/NACK bit using the DFT input position #12 according to FIG. 7.

Now, in the above example, forward data resource channels #0˜#5 are allocated to the mobile stations A, B, C and D, and thus, input positions #1, #2, #3, #5, #9, #10, #11 and #13 are determined as the input positions to be unused among the DFT input positions for reverse ACK/NACK bit transmission. Therefore, it can be noted that it has already been determined that 8 DFT input positions will be unused, and this means that 8 DFT input positions needed for measuring an interference of the subtile have already been secured.

Therefore, it can be considered that the base station is free from the restriction that it should binds resource channels on a two-by-two basis in allocating the remaining resources for transmitting data to the mobile stations. That is, the remaining resources allocable to the base station include two forward data resource channels of the forward data resource channel #6 and the forward data resource channel #7, and the base station can allocate the forward data resource channel #6 to the mobile station E and the mobile station F, and allocate the forward data resource channel #7 to the mobile stations G and H. In this case, the mobile station E can transmit an ACK/NACK bit using the DFT input position #6; the mobile station F can transmit an ACK/NACK bit using the DFT input position #14; the mobile station G can transmit an ACK/NACK bit using the DFT input position #7; and the mobile station H can transmit an ACK/NACK bit using the DFT input position #15.

As described above, the method proposed by the present invention, compared to the prior art, has less resource allocation restriction in the remaining resource allocation when a large amount of resources are allocated to particular mobile stations.

The above method can be extended in a similar way even for the case where data streams are transmitted over more than two layers in the forward link.

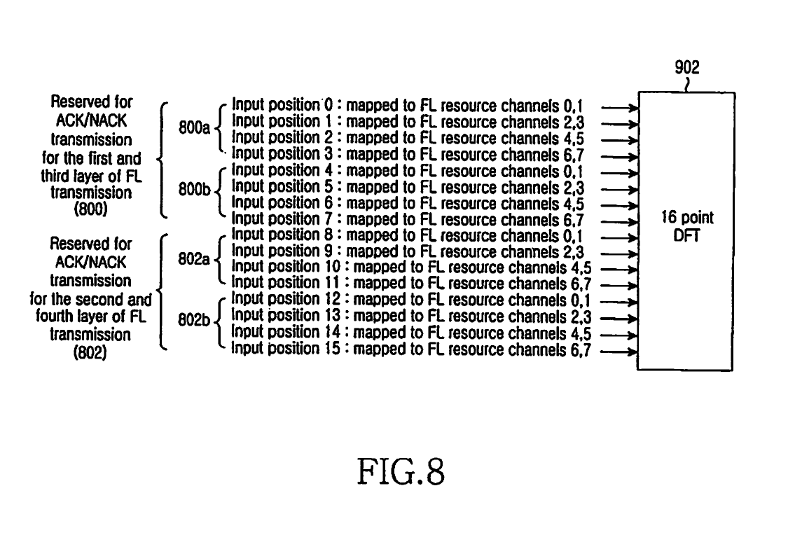

FIG. 8 is a diagram illustrating a mapping relationship between forward data resource channels for four layers and DFT input positions for reverse ACK/NACK bit transmission when forward data transmission is performed over four layers according to a preferred embodiment of the present invention.

As illustrated in FIG. 8, when a base station transmits data over four layers in the forward link, the mapping relationship between forward data resource channels and DFT 902 input positions for reverse ACK/NACK bit transmission, proposed by the present invention, is defined as follows.

DFT 902 input positions #0 to #3 (800a) to be mapped to a first subtile 300 in FIG. 3 are allocated for the forward data resource channels #0 to #7 corresponding to a first layer, and DFT 902 input positions #8 to #11 (802a) to be mapped to the first subtile 300 are allocated for the forward data resource channels #0 to #3 corresponding to a second layer. Further, DFT 902 input positions #4 to #7 (800b) to be mapped to the first subtile 300 in FIG. 3 are allocated for the forward data resource channels #0 to #7 corresponding to a third layer, and DFT 902 input positions #12 to #15 (802b) to be mapped to the first subtile 300 in FIG. 3 are allocated for the forward data resource channels #0 to #7 corresponding to a fourth layer.

Although not shown in FIG. 8, the same method is applied to the remaining forward data resource channels.

That is, DFT input positions #0 to #3 (800a) to be mapped to a second subtile (i.e. to be mapped to reference numeral 302 in FIG. 3) are allocated for the forward data resource channels #8 to #15 corresponding to the first layer, and DFT 902 input positions #8 to #11 (802a) to be mapped to the second subtile are allocated for the forward data resource channels #8 to #15 corresponding to the second layer. DFT 902 input positions #4 to #7 (800b) to be mapped to the second subtile are allocated for the forward resource channels #8 to #15 corresponding to a third layer, and DFT 902 input positions #12 to #15 (802b) to be mapped to the second subtile are allocated for the forward resource channels #8 to #15 corresponding to a fourth layer.

As described above, it should be ensured even in FIG. 8 that at least 8 of the DFT 902 input positions are unused. This is to use them in measuring an interference for each subtile as described above. However, as shown in FIG. 8, it can be understood that all DFT input positions are available in the mapping relationship between the forward data resource channels corresponding to four layers used for forward data stream transmission and the DFT input positions for reverse ACK/NACK bit transmission for the data streams received over the four layers, proposed by the present invention.

Therefore, for interference measurement with the mapping relationship, it should be ensured that at least 8 of the 16 input positions are always unused, and this means that there is a need for some restriction on the forward resource allocation. A detailed description will now be made of a reverse ACK/NACK bit transmission method with reference to FIG. 8 for the case where data streams are transmitted over four layers under the assumption that resource channels are bound on a four-by-four basis for forward resource allocation.

For convenience, it is assumed that there are a total of 8 forward data resource channels. Further, it is assumed that the base station transmits data streams to mobile stations A, B, C and D over forward data resource channels #0, #1, #2 and #3 and their associated four layers in such a manner that it transmits a data stream to the mobile station A using a first layer, transmits a data stream to the mobile station B using a second layer, transmits a data stream to the mobile station C using a third layer, and transmits a data stream to the mobile station D using a fourth layer.

In addition, it is assumed that the base station transmits data streams to mobile stations E, F, G and H over forward data resource channels #4, #5, #6 and #7 and their associated four layers in such a manner that it transmits a data stream to the mobile station E using a first layer, transmits a data stream to the mobile station F using a second layer, transmits a data stream to the mobile station G using a third layer, and transmits a data stream to the mobile station H using a fourth layer.

As described above, the mobile station A receives the data stream over the forward data resource channels #0, #1, #2 and #3 and their associated first layer, and DFT input positions corresponding thereto, referring to FIG. 8, are DFT input positions #0 and #1.

From reference numerals 800 and 802 of FIG. 8, it can be seen that the layer #1 and the layer #3; and the layer #2 and the layer #4 share the DFT input positions in the same region. That is, reference numeral 800 shows that the DFT input positions to be used for transmitting reverse ACK/NACK bits for the data streams received over the layer #1 and the DFT input positions to be used for transmitting reverse ACK/NACK bits for the data streams received over the layer #3 are shared, and reference numeral 802 shows that the DFT input positions to be used for transmitting reverse ACK/NACK bits for the data streams received over the layer #2 and the DFT input positions to be used for transmitting reverse ACK/NACK bits for the data streams received over the layer #4 are shared.

In the proposed method, when several layers share the DFT input positions in the same region in this manner, the ACK/NACK bit transmission for the layer corresponding to the lower index among several layers sharing the DFT input positions uses the DFT input positions corresponding to lower indexes among the input positions mapped to multiple allocated forward data resource channels, and the ACK/NACK bit transmission for the layer corresponding to the higher index uses the DFT input positions corresponding to higher indexes among the input positions mapped to the multiple allocated forward data resource channels. On the contrary, the ACK/NACK bit transmission for the layer corresponding to the lower index can use the DFT input positions corresponding to the higher indexes among input positions mapped to the multiple allocated forward data resource channels.

That is, in the foregoing example, because the mobile station A receives a data stream over the resource channels #0, #1, #2 and #3 and the first layer 800a, the DFT input positions corresponding to the first layer are the DFT input positions #0, #1, #2 and #3, and the mobile station A uses the DFT input position #0 among them. Because the mobile station B receives a data stream over the resource channels #0, #1, #2 and #3 and the second layer 802a, the DFT input positions corresponding to the second layer are the DFT input positions #8, #9, #10 and #11, and the mobile station B uses the DFT input position #8 among them.

Because the mobile station C receives a data stream over the resource channels #0, #1, #2 and #3 and the third layer 800b, the DFT input positions corresponding to the third layer are the DFT input positions #4, #5, #6 and #7, and the mobile station C uses the DFT input position #4 among them. Because the mobile station D receives a data stream over the resource channels #0, #1, #2 and #3 and the fourth layer 802b, the DFT input positions corresponding to the fourth layer are the DFT input positions #12, #13, #14 and #15, and the mobile station D uses the DFT input position #12 among them. In the same manner, mobile stations E, F, G and H transmit ACK/NACK bits over DFT input positions #2, #10, #6 and #14, respectively. Because the DFT input positions unused in the above example are DFT input positions #1, #3, #5, #7, #9, #11, #13 and #15 and the number of the unused DFT input positions is 8, there is no problem in measuring an interference of each subtile.

Although the present invention has been described herein under the assumption that the 8 DFT input positions are needed for measuring an interference of the subtile, it is not intended to limit the present invention and the number of DFT input positions is subject to change, so the method proposed by the present invention can be freely modified.

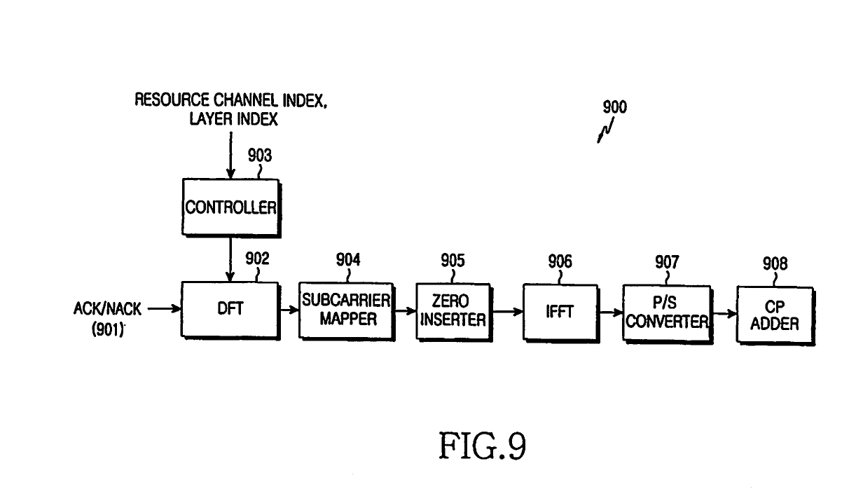

FIG. 9 is a diagram illustrating a structure of an ACK/NACK transmitter 900 according to a preferred embodiment of the present invention.

Referring to FIG. 9, 901 indicates an ACK/NACK bit that a mobile station transmits upon receiving data over a forward data channel. Its value is determined depending on whether the mobile station has succeeded in demodulation of its received forward data, or has failed in the demodulation and thus issued a retransmission request.

The ACK/NACK bit 901 is input to a 16-point DFT 902, and this process is controlled by a controller 903. The controller 903 controls the ACK/NACK bit to be input to the DFT 902 in the manner described in FIGS. 8 and 9 depending on received forward data resource channel indexes and layer indexes used for forward data transmission. An output of the DFT 902 undergoes a subcarrier mapping process in a subcarrier mapper 904, and the mapping result is carried on a subcarrier in the manner described in FIG. 3. Assuming that the OFDM system employs an 512-size FFT, subcarrier positions corresponding to the remaining values except for the remaining values of the subcarrier mapper 904 are filled with ‘0’s in a zero inserter 905, and the resulting signal is transmitted through the general OFDM symbol generation procedure by means of an IFFT 906, a P/S converter 907, and a CP adder 908. In FIG. 9, the DFT 902, the subcarrier mapper 904, the zero inserter 905, the IFFT 906, the P/S converter 907 and the CP adder 908 constitute a transmission module.

That is, in FIG. 9, the controller 903 selects one of DFT input positions mapped to the data channels over which received data streams are transmitted in the group corresponding to the layer over which the received data stream is transmitted from among the input positions of the DFT 902. Here, the DFT 902 has all input positions that are grouped into N groups separately for N layers that transmit different data streams, and the input positions in the groups are mapped to different data channels. The transmission module transmits an ACK/NACK signal for the data stream received over the DFT input position selected by the controller 903.

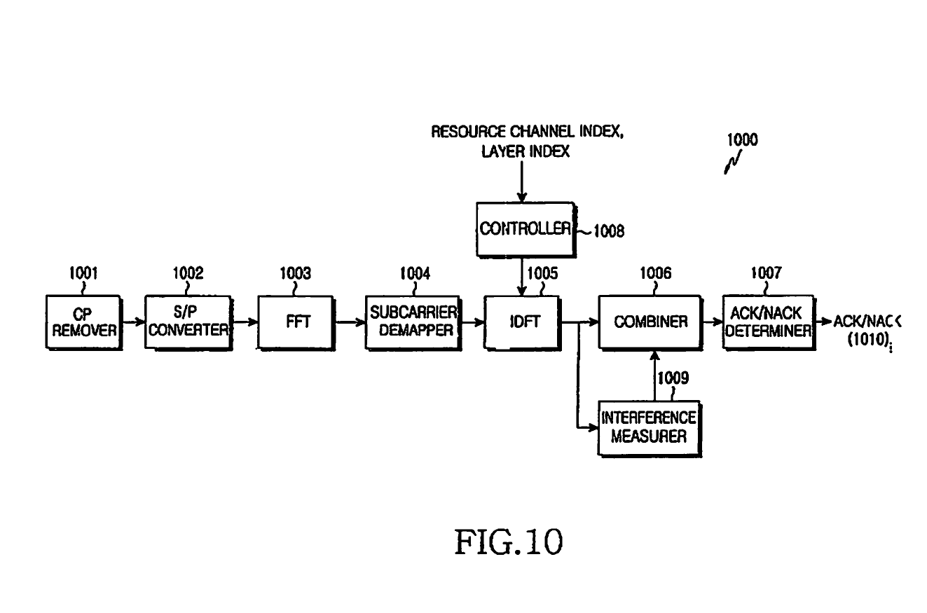

FIG. 10 is a diagram illustrating a structure of an ACK/NACK receiver 1000 according to a preferred embodiment of the present invention.

Because one tile includes 4 subtiles and the same information is transmitted in each of the subtiles, it can be considered that the same signal is repeatedly transmitted over one tile four times. A description will be made of a block structure of the receiver 1000 that receives an ACK/NACK bit transmitted in the reverse link according to an embodiment of the present invention. In the receiver 1000, a CP remover 1001, a Serial-to-Parallel (S/P) converter 1002, and an FFT 1003 are equal in operation to those in the general OFDM symbol receiver.

That is, upon receiving a signal corresponding to one subtile, the CP remover 1001 removes a CP from the received signal, and the S/P converter 1002 converts the CP-removed serial signal into a parallel signal, and outputs the parallel signal to the FFT 1003. The FFT 1003 FFT-transforms the parallel signal and outputs the FFT-transformed signal to a subcarrier demapper 1004.

The subcarrier demapper 1004 performs subcarrier demapping on the signals FFT-transformed by the FFT 1003. That is, in the embodiment of the present invention, the subcarrier demapper 1004 extracts symbols for the subcarriers corresponding to the subtiles of FIG. 3 from among the outputs of the FFT 1003.

A controller 1008 receives forward resource channel indexes and layer indexes used for data transmission according to the scheduling result, and outputs, to an Inverse Discrete Fourier Transformer (IDFT) 1005, indexes of DFT input positions that the mobile station has used for ACK/NACK bit transmission in the reverse link, and indexes of unused DFT input positions.

That is, the controller 1008 selects one of DFT input positions mapped to data channels over which the data streams are transmitted in the group corresponding to the layer over which the data stream is transmitted from among input positions of a DFT. Here, the DFT has all input positions grouped into N groups separately for N layers that transmit different data streams, and the input positions in the groups are mapped to different data channels. Then the IDFT 1005 IDFT-transforms the received signal, and outputs the IDFT-transformed signal to a combiner 1006 or an interference measurer 1009. Here, the IDFT 1005 selects, from one subtile, a signal corresponding to the DFT input positions unused for ACK/NACK bit transmission, and outputs the selected signal to the interference measurer 1009, and the IDFT 1005 selects, from one subtile, a signal corresponding to the DFT input positions used for ACK/NACK bit transmission, and outputs the selected signal to the combiner 1006. That is, the IDFT 1005 outputs the received ACK/NACK signal to the combiner 1006 over the DFT input position selected by the controller 1008.

The interference measurer 1009 measures an interference for each of subtiles 300 to 306 using the signal corresponding to the DFT input positions unused for the ACK/NACK bit transmission in each subtile, and outputs the measure interference for every subtile to the combiner 1006. At this point, the interference measurer 1009 measures an interference using the unused DFT 902 input positions calculated by the controller 1008 according to the forward data resource allocation result as described in FIGS. 8 and 9. That is, the interference measurer 1009 measures, from the signals output from the IDFT 1005, an interference for each of the subtiles using the remaining input positions except for one selected by the controller 1008 among the DFT input positions mapped to the transmitted data channels.

The combiner 1006 determines a weight for combining ACK/NACK bits repeatedly received over four subtiles constituting one tile depending on the interference measured separately for each subtile by the interference measurer 1009, combines the repeatedly received ACK/NACK bits after IDFT-transformed by the IDFT 1005 using the determined weight, and outputs the combining result to an ACK/NACK determiner 1007.

The ACK/NACK determiner 1007 determines whether the combined signal output from the combiner 1006 is an ACK bit or a NACK bit according to a predetermined procedure, and outputs the determined ACK/NACK bit 1010.

In FIG. 10, the CP remover 1001, the S/P converter 1002, FFT 1003, the subcarrier demapper 1004, the IDFT 1005, combiner 1006, ACK/NACK determiner 1007, and the interference measurer 1009 constitute a reception module.

As is apparent from the foregoing description, in supporting H-ARQ for multi-layer transmission for transmitting data over multiple layers, the present invention enables more flexible forward resource allocation with use of the same amount of ACK/NACK transmission resources.

While the invention has been shown and described with reference to a certain preferred embodiments thereof, it will be understood by those skilled in the art that various changes in form and details may be made therein without departing from the spirit and scope of the invention as defined by the appended claims.

What is claimed is:

1. A method for transmitting an Acknowledge (ACK)/Non-Acknowledge (NACK) signal to support Hybrid Automatic Repeat reQuest (H-ARQ) in an Orthogonal Frequency Division Multiplexing (OFDM) system, the method comprising the steps of:
selecting one of a plurality of Discrete Fourier Transformer (DFT) input positions mapped to data channels over which a received data stream is transmitted in a group corresponding to a layer over which the received data stream is transmitted, wherein the plurality of input positions are grouped into N groups for N layers for transmitting different data streams, and the input positions in each group are mapped to different data channels; and
transmitting an ACK/NACK signal for the received data stream over the selected DFT input position.

2. The method of claim 1, wherein remaining input positions except for the at least one selected input position are used for interference measurement.

3. The method of claim 1, wherein the selection comprises:
selecting a DFT input position mapped to a data channel with a lowest index from among the data channels over which the received data stream is transmitted.

4. The method of claim 1, wherein when N is 2,
DFT input positions #0 to #7 included in a group of DFT input positions corresponding to a first layer out of the 2 layers are mapped to data channels #0 to #7, respectively; and
DFT input positions #8 to #15 included in a group of DFT input positions corresponding to a second layer out of the 2 layers are mapped to data channels #0 to #7, respectively.

5. The method of claim 1, wherein when N is 4,
DFT input positions #0 to #3 included in a group of DFT input positions corresponding to a first layer among the 4 layers are mapped to two of data channels #0 to #7, respectively;
DFT input positions #8 to #11 included in a group of DFT inputs corresponding to a second layer among the 4 layers are mapped to two of data channels #0 to #7, respectively;
DFT input positions #4 to #7 included in a group of DFT inputs corresponding to a third layer among the 4 layers are mapped to two of data channels #0 to #7, respectively; and
DFT input positions #12 to #15 included in a group of DFT inputs corresponding to a fourth layer among the 4 layers are mapped to two of data channels #0 to #7, respectively.

6. The method of claim 1, wherein the transmitting comprises:
transmitting an ACK/NACK signal for the received data stream over one of 4 subtiles comprising a tile having time/frequency resources allocated for transmitting ACK/NACK signals for received data channels.

7. A method for receiving an Acknowledge (ACK)/Non-Acknowledge (NACK) signal to support Hybrid Automatic Repeat reQuest (H-ARQ) in an Orthogonal Frequency Division Multiplexing (OFDM) system, the method comprising the steps of:
selecting one of a plurality of Discrete Fourier Transformer (DFT) input positions mapped to data channels over which a data stream is transmitted in a group corresponding to a layer over which the data stream is transmitted, wherein the plurality of input positions are grouped into N groups for N layers for transmitting different data streams, and the input positions in each group are mapped to different data channels; and
receiving an ACK/NACK signal for the transmitted data stream over the selected DFT input position.

8. The method of claim 7, wherein remaining input positions except for the at least one selected input position are used for interference measurement.

9. The method of claim 7, wherein the selection comprises:
selecting a DFT input position mapped to a data channel with a lowest index from among the transmitted data channels.

10. The method of claim 7, wherein when N is 2,
DFT input positions #0 to #7 included in a group of DFT input positions corresponding to a first layer out of the 2 layers are mapped to data channels #0 to #7, respectively; and
DFT input positions #8 to #15 included in a group of DFT input positions corresponding to a second layer out of the 2 layers are mapped to data channels #0 to #7, respectively.

11. The method of claim 7, wherein when N is 4,
DFT input positions #0 to #3 included in a group of DFT input positions corresponding to a first layer among the 4 layers are mapped to two of data channels #0 to #7, respectively;
DFT input positions #8 to #11 included in a group of DFT inputs corresponding to a second layer among the 4 layers are mapped to two of data channels #0 to #7, respectively;
DFT input positions #4 to #7 included in a group of DFT inputs corresponding to a third layer among the 4 layers are mapped to two of data channels #0 to #7, respectively; and
DFT input positions #12 to #15 included in a group of DFT inputs corresponding to a fourth layer among the 4 layers are mapped to two of data channels #0 to #7, respectively.

12. The method of claim 7, wherein the reception comprises:
receiving the ACK/NACK signal over one of 4 subtiles comprising a tile having time/frequency resources allocated for transmitting ACK/NACK signals for transmitted data channels.

13. An apparatus for transmitting an Acknowledge (ACK)/Non-Acknowledge (NACK) signal to support Hybrid Automatic Repeat reQuest (H-ARQ) in an Orthogonal Frequency Division Multiplexing (OFDM) system, the apparatus comprising:
a controller for selecting one of a plurality of Discrete Fourier Transformer (DFT) input positions mapped to data channels over which a received data stream is transmitted in a group corresponding to a layer over which the received data stream is transmitted, wherein the plurality of input positions are grouped into N groups for N layers for transmitting different data streams, and the input positions in each group are mapped to different data channels; and
a transmission module for transmitting an ACK/NACK signal for the received data stream over the DFT input position selected by the controller.

14. The apparatus of claim 13, wherein remaining input positions except for the at least one selected input position are used for interference measurement.

15. The apparatus of claim 13, wherein the controller selects a DFT input position mapped to a data channel with a lowest index from among data channels over which the received data stream is transmitted.

16. The apparatus of claim 13, wherein when N is 2,
DFT input positions #0 to #7 included in a group of DFT input positions corresponding to a first layer out of the 2 layers are mapped to data channels #0 to #7, respectively; and
DFT input positions #8 to #15 included in a group of DFT input positions corresponding to a second layer out of the 2 layers are mapped to data channels #0 to #7, respectively.

17. The apparatus of claim 13, wherein when N is 4,
DFT input positions #0 to #3 included in a group of DFT input positions corresponding to a first layer among the 4 layers are mapped to two of data channels #0 to #7, respectively;
DFT input positions #8 to #11 included in a group of DFT inputs corresponding to a second layer among the 4 layers are mapped to two of data channels #0 to #7, respectively;
DFT input positions #4 to #7 included in a group of DFT inputs corresponding to a third layer among the 4 layers are mapped to two of data channels #0 to #7, respectively; and
DFT input positions #12 to #15 included in a group of DFT inputs corresponding to a fourth layer among the 4 layers are mapped to two of data channels #0 to #7, respectively.

18. The apparatus of claim 13, wherein the transmission module transmits the ACK/NACK signal over one of 4 subtiles comprising a tile having time/frequency resources allocated for transmitting ACK/NACK signals for received data channels.

19. An apparatus for receiving an Acknowledge (ACK)/Non-Acknowledge (NACK) signal to support Hybrid Automatic Repeat reQuest (H-ARQ) in an Orthogonal Frequency Division Multiplexing (OFDM) system, the apparatus comprising:
a controller for selecting one of a plurality of Discrete Fourier Transformer (DFT) input positions mapped to data channels over which a data stream is transmitted in a group corresponding to a layer over which a data stream is transmitted, wherein the plurality of input positions are grouped into N groups for N layers for transmitting different data streams, and the input positions in each group are mapped to different data channels; and
a reception module for receiving an ACK/NACK signal for the transmitted data stream over the DFT input position selected by the controller.

20. The apparatus of claim 19, wherein the reception module comprises:
an Inverse Discrete Fourier Transformer (IDFT) for outputting, to a combiner, the ACK/NACK signal received over the DFT input position selected by the controller;
an interference measurer for measuring, from the signals output from the IDFT, an interference for subtiles using remaining input positions except for the selected input position; and
the combiner for determining a weight for combining the ACK/NACK signal output from the IDFT using the interference measured by the interference measurer, and combining ACK/NACK signals repeatedly received by the IDFT using the determined weight.

21. The apparatus of claim 19, wherein the controller selects a DFT input position mapped to a data channel with a lowest index from among the transmitted data channels.

22. The apparatus of claim 19, wherein when N is 2,
DFT input positions #0 to #7 included in a group of DFT input positions corresponding to a first layer out of the 2 layers are mapped to data channels #0 to #7, respectively; and
DFT input positions #8 to #15 included in a group of DFT input positions corresponding to a second layer out of the 2 layers are mapped to data channels #0 to #7, respectively.

23. The apparatus of claim 19, wherein when N is 4,
DFT input positions #0 to #3 included in a group of DFT input positions corresponding to a first layer among the 4 layers are mapped to two of data channels #0 to #7, respectively;
DFT input positions #8 to #11 included in a group of DFT inputs corresponding to a second layer among the 4 layers are mapped to two of data channels #0 to #7, respectively;
DFT input positions #4 to #7 included in a group of DFT inputs corresponding to a third layer among the 4 layers are mapped to two of data channels #0 to #7, respectively; and
DFT input positions #12 to #15 included in a group of DFT inputs corresponding to a fourth layer among the 4 layers are mapped to two of data channels #0 to #7, respectively.

24. The apparatus of claim 19, wherein the reception module receives the ACK/NACK signal over one of 4 subtiles comprising a tile having time/frequency resources allocated for transmitting ACK/NACK signals for received data channels.
